(19) United States
(12) Patent Application Publication
(10) Pub. No.: US 2013/0010816 A1
(43) Pub. Date: Jan. 10, 2013

(54) METHOD, SYSTEM, COMMUNICATIONS NETWORK AND COMPUTER PROGRAM PRODUCT FOR TRANSMITTING INFORMATION IN A COMMUNICATIONS NETWORK

(75) Inventor: Walter Keller, Ratingen (DE)

(73) Assignee: DEUTSCHE TELEKOM AG, Bonn (DE)

(21) Appl. No.: 13/520,579

(22) PCT Filed: Jan. 3, 2011
(86) PCT No.: PCT/EP2011/000002

§ 371 Date: Sep. 24, 2012

Related U.S. Application Data
(60) Provisional application No. 61/293,268, filed on Jan. 8, 2010.

(30) Foreign Application Priority Data
Jan. 8, 2010 (EP) 10000127.0

(51) Int. Cl. H04J 3/02

(52) U.S. Cl. 370/535; 370/537

(57) ABSTRACT

A method for transmitting first data to a first decentralized unit in a communications network from a central unit via a distribution point and via a first subscriber line serving the first decentralized unit and at least one other subscriber lines serving at least one other decentralized unit includes: splitting the first data at the central unit; transmitting the split first data from the central unit to the distribution point using the first subscriber line and the at least one other subscriber line; and merging, at the distribution point, the split first data on the first subscriber line for transmission of the first data to the first decentralized unit.

### CROSS-REFERENCE TO RELATED APPLICATIONS

This patent application is a national stage entry under 35 U.S.C. §371 of International Application No. PCT/EP2011/000002, filed Jan. 3, 2011, and claims priority to European Patent Application No. EP 10000127.0, filed Jan. 8, 2010, and U.S. Provisional Patent Application No. 61/293,268, filed Jan. 8, 2010. The International Application was published in English on Jul. 14, 2011, as WO 2011/083071 A1.

### FIELD

The present invention relates to a method, a system, a communications network, and a computer program product for transmitting information in a communications network between a central unit on the one hand and a first and second decentralized unit on the other hand via a distribution point.

### BACKGROUND

Users often desire higher data transmission bandwidth when using Digital Subscriber Lines (DSL), e.g. for the transmission of multimedia content such a videos and/or games. In order to realize higher data transmission capacities for subscribers, the cable lengths of the cables connecting the subscriber terminal devices with the central units can be reduced. A conventional technique is to install optical fibers from central units to distribution points in order to enhance data transmission capacities (i.e. reduce the cable lengths) or to use port bonding (a plurality of DSL ports are physically provisioned to the end user and the total bandwidth is equal to the sum of all provisioned ports) according to the specifications of ITU G.998.x or G.Bond.

The document XP002571200 (Honig M. L., Steiglitz K.: “multichannel signal processing for data communications in the presence of crosstalk”, IEEE Transactions on communications, vol. 38, no. 4, 4 Apr. 1990, pages 551-558) describes a system for multichannel signal processing for data communications in the presence of crosstalk, wherein multichannel adaptive FIR filters are used to cancel near- and far-end crosstalk.

However, these methods are costly as either the optical fibers need to be installed or the subscribers need to pay for a plurality of subscriber lines.

### SUMMARY

In an embodiment, the present invention provides a method for transmitting first data to a first decentralized unit in a communications network from a central unit via a distribution point and via a first subscriber line serving the first decentralized unit and at least one other subscriber line serving at least one other decentralized unit. The method includes: splitting the first data at the central unit; transmitting the split first data from the central unit to the distribution point using the first subscriber line and the at least one other subscriber line; and merging, at the distribution point, the split first data on the first subscriber line for transmission of the first data to the first decentralized unit.

### BRIEF DESCRIPTION OF THE DRAWINGS

FIG. 1 schematically illustrates a part of a communications network including a central unit and a plurality of decentralized units (subscriber terminals).

FIG. 2 schematically illustrates a more detailed representation of the connection between a central unit and a plurality of decentralized units according to a conventional system.

FIG. 3 schematically illustrates a more detailed representation of the connection between a central unit and a plurality of decentralized units according to an embodiment of the present invention.

### DETAILED DESCRIPTION

Embodiments of the present invention provide a method, a system, a communications network, and a computer program product for transmitting information in a communications network between a central unit on the one hand and a first and second decentralized unit on the other hand via a distribution point such that transmission bandwidth between the central unit and the decentralized units is enhanced without bearing the costs of providing optical fibers between the central unit and the distribution point.

In an embodiment, the present invention provides a method for transmitting information in a communications network between a central unit on the one hand and a first and second decentralized unit on the other hand via a distribution point, wherein the communications network includes first and second subscriber lines serving the first and second decentralized unit for the transmission of first data from the central unit to the first decentralized unit and for the transmission of second data from the central unit to the second decentralized unit. In a first exemplary embodiment, the method includes the following steps:

multiplexing (or splitting) the first data at the central unit on the first and second subscriber lines or on the first subscriber line and an additional subscriber line,

transmitting the first data from the central unit to the distribution point using the first and second subscriber lines or using the first subscriber line and the additional subscriber line, and

demultiplexing (or merging) at the distribution point the first data on the first subscriber line for transmission to the first decentralized unit.

In a second exemplary embodiment, the method includes the following steps:

multiplexing the first and second data at the central unit (on the first and second subscriber lines),

commonly transmitting the multiplexed first and second data from the central unit to the distribution point using the first and second subscriber lines, and

demultiplexing at the distribution point the first data on the first subscriber line for transmission to the first decentralized unit and the second data on the second subscriber line for transmission to the second decentralized unit.

Thereby, it is advantageously possible to use the full transmission capacity (or bandwidth) of the subscriber lines present between the central unit and the distribution point to transmit data independent on whether such data concern the first decentralized unit or the second decentralized unit. Usually, a multitude of subscriber lines and decentralized units are present that are served by the central unit, e.g. a few tens of decentralized units or even a few hundreds of decentralized units. In an embodiment, a cable device is located between the central unit and the distribution point, wherein the cable device typically provides 100 or 200 or 500 subscriber lines, which are all used to transmit data to and/or from the decentralized units. The first subscriber line serves the first decentralized unit and the second subscriber line serves the second decentralized unit. The first and/or second subscriber lines are usually each copper double wire but could also be a multitude of copper double wires. The additional subscriber lines (usually also copper double wires) are only used between the central unit and the distribution point. The sharing of all the subscriber lines between the central unit and the distribution point is at least used for the down link direction, i.e. for the transmission of first data (from the central unit to the first decentralized unit) and for the transmission of second data (from the central unit to the second decentralized unit). A higher bandwidth is possible to be realized between the central unit and the decentralized unit as usually:

there are either additional (non-used) subscriber lines present between the central unit and the distribution point that can be used for transmitting the first data and the second data separately (according to the first exemplary embodiment), or

the decentralized units do not need the full transmission capacity of their respective subscriber line at any time and therefore, it is possible to use the available capacity of the first and the second subscriber lines for a common transmission of the first and second data (according to the second exemplary embodiment of the present invention). This is also called statistical multiplex. Embodiments of the present invention provide for a sharing of the transmission capacity on a part of the distance between the central unit and the decentralized unit, namely between the central unit and the distribution point.

In an embodiment, the first and second subscriber lines serve the first and second decentralized unit for the transmission of third data from the first decentralized unit to the central unit and for the transmission of fourth data from the second decentralized unit to the central unit, including the steps of either:

multiplexing (or splitting) the third data at the distribution point on the first and second subscriber lines or on the first subscriber line and on an additional subscriber line,

transmitting the third data from the distribution point to the central unit using the first and second subscriber lines or on the first subscriber line and on the additional subscriber line, and

demultiplexing (or merging) the third data at the central unit

or

multiplexing the third and fourth data at the distribution point on the first and second subscriber lines,

commonly transmitting the multiplexed third and fourth data from the distribution point to the central unit using the first and second subscriber lines, and

demultiplexing the third and fourth data at the central unit.

Thereby, it is advantageously possible to provide for a sharing of the resources between the central unit and the distribution point also for the data transmission in the upload direction, i.e. from the decentralized unit towards the central unit. Again, it is possible

that the third data are transmitted separately from the fourth data on the first and second subscriber lines or on the first subscriber line and on the additional subscriber line, or

that the third data and the fourth data are transmitted commonly on the first and second subscriber lines.

It is possible to combine:

a common transmission of the first and second data (downlink direction) with a common transmission of the third and fourth data (uplink direction), or

a common transmission of the first and second data (downlink direction) with a separate transmission of the third and fourth data (uplink direction), or

a separate transmission of the first and second data (downlink direction) with a common transmission of the third and fourth data (uplink direction), or

a separate transmission of the first and second data (downlink direction) with a separate transmission of the third and fourth data (uplink direction).

In a further embodiment, for the common transmission of the first and second data from the central unit to the distribution point, a maximum bandwidth is assigned to the first data corresponding to the transmission capacity of the first subscriber line between the distribution point and the first decentralized unit and/or

wherein for the common transmission of the third and fourth data from the distribution point to the central unit, a maximum bandwidth is assigned to the third data corresponding to the transmission capacity of the first subscriber line between the distribution point and the first decentralized unit.

It is thereby advantageously possible to provide for a maximum transmission throughput and therefore a maximum quality of service for as many subscribers as possible. If, e.g., the transmission capacity (or bandwidth) between the distribution point and the first decentralized unit (i.e. the subscriber terminal) is limited to 1 Mbaud (e.g. due to the signal attenuation of the copper double line between the distribution point and the first decentralized unit) because of a certain cable length of this line, then the first decentralized unit will at most be allotted 1 Mbaud for the multiplexed part of the transmission line between the central unit and the decentralized unit.

In a further embodiment, at least one additional subscriber line is used between the central unit and the distribution point for commonly transmitting the first and second data and/or the third and fourth data. The use of such additional subscriber lines that are at least not in use for broad band transmission makes it possible to further enhance the transmission bandwidth on the multiplexed part of the transmission line between the central unit and the decentralized unit.

In a further embodiment, the first, second, third and fourth data each include a narrow band portion, wherein at least one of the narrow band portions are transmitted on the first or second subscriber line or on the at least one additional subscriber line.

It is possible to transmit the narrow band signal of the decentralized units either on their dedicated subscriber line or it is alternatively also possible to transmit these data on a different subscriber line.

In a further embodiment, the common or separate transmission of the first, second, third and/or fourth data is realized dependent on the attenuation and/or cross talk properties of the first and second subscriber line and/or of the at least one additional subscriber line between the central unit and the distribution point.

Thereby, it is advantageously possible to further enhance the data transmission capacity between the central unit and the distribution point. It is possible to automatically measure (the attenuation and or other electromagnetic properties of the data transmission) one or more of the double cable links between the central unit and the distribution point such that with regard to the attenuation but also with regard to cross-talk an optimized data transmission can be performed.

In an embodiment, the present invention provides a system for transmitting information, especially in a communications network, between a central unit on the one hand and a first and second decentralized unit on the other hand via a distribution point, wherein the system uses first and second subscriber lines serving the first and second decentralized unit for the transmission of first data from the central unit to the first decentralized unit, wherein the system includes a first multiplex unit provided for multiplexing the first data at the central unit on the first and second subscriber lines or on the first subscriber line and on an additional subscriber line, wherein the first data are transmitted from the central unit to the distribution point using the first and second subscriber lines or using the first subscriber line and using the additional subscriber line, and wherein the system includes a second multiplex unit provided for demultiplexing, at the distribution point, the first data on the first subscriber line for transmission to the first decentralized unit (UE1).

In an embodiment, the present invention provides a system for transmitting information, especially in a communications network, between a central unit on the one hand and a first and second decentralized unit on the other hand via a distribution point, wherein the system uses first and second subscriber lines serving the first and second decentralized unit for the transmission of first data from the central unit to the first decentralized unit and for the transmission of second data from the central unit to the second decentralized unit, wherein the system includes a first multiplex unit provided for multiplexing the first and second data at the central unit on the first and second subscriber lines, wherein the first and second data are commonly transmitted from the central unit to the distribution point using the first and second subscriber lines, and wherein the system includes a second multiplex unit provided for demultiplexing, at the distribution point, the first data on the first subscriber line for transmission to the first decentralized unit (UE1) and the second data on the second subscriber line for transmission to the second decentralized unit (UE2).

In an embodiment, the first and second subscriber lines serve the first and second decentralized unit for the transmission of third data from the first decentralized unit to the central unit, wherein the second multiplex unit is provided for multiplexing the third data at the distribution point on the first and second subscriber lines or on the first subscriber line and on the additional subscriber line, wherein the third data are transmitted from the distribution point to the central unit using the first and second subscriber lines or using the first subscriber line and using the additional subscriber line, and wherein the first multiplex unit is provided for demultiplexing the third data at the central unit.

In a further embodiment, the first and second subscriber lines serve the first and second decentralized unit for the transmission of third data from the first decentralized unit to the central unit and for the transmission of fourth data from the second decentralized unit to the central unit, wherein the second multiplex unit is provided for multiplexing the third and fourth data at the distribution point on the first and second subscriber lines, wherein the third and fourth data are commonly transmitted from the distribution point to the central unit using the first and second subscriber lines, and wherein the first multiplex unit is provided for demultiplexing the third and fourth data at the central unit.

Thereby, it is advantageously possible that a higher bandwidth is realized between the central unit and the decentralized unit as it is usual that the decentralized units do not need the full transmission capacity of their respective subscriber line at any time. Embodiments of the present invention provide for a sharing of the transmission capacity on a part of the distance between the central unit and the decentralized unit, namely between the central unit and the distribution point.

In a further embodiment, the first and second subscriber lines (as well as the additional subscriber line) are provided as pairs of wire lines, for example, as pairs of copper wire lines, which is very cost effective.

In an embodiment, the present invention provides a communications network including a system for transmitting information, especially in a communications network, between a central unit on the one hand and a first and second decentralized unit on the other hand via a distribution point, wherein the system uses first and second subscriber lines serving the first and second decentralized unit for the transmission of first data from the central unit to the first decentralized unit, wherein the system includes a first multiplex unit provided for multiplexing the first data at the central unit on the first and second subscriber lines or on the first subscriber line and on an additional subscriber line, wherein the first data are transmitted from the central unit to the distribution point using the first and second subscriber lines or using the first subscriber line and using the additional subscriber line, and wherein the system includes a second multiplex unit provided for demultiplexing, at the distribution point, the first data on the first subscriber line for transmission to the first decentralized unit (UE1).

In an embodiment, the present invention provides a communications network including a system for transmitting information, especially in a communications network, between a central unit on the one hand and a first and second decentralized unit on the other hand via a distribution point, wherein the system uses first and second subscriber lines serving the first and second decentralized unit for the transmission of first data from the central unit to the first decentralized unit and for the transmission of second data from the central unit to the second decentralized unit, wherein the system includes a first multiplex unit provided for multiplexing the first and second data at the central unit on the first and second subscriber lines, wherein the first and second data are commonly transmitted from the central unit to the distribution point using the first and second subscriber lines, and wherein the system includes a second multiplex unit provided for demultiplexing, at the distribution point, the first data on the first subscriber line for transmission to the first decentralized unit (UE1) and the second data on the second subscriber line for transmission to the second decentralized unit (UE2).

Further embodiments of the present invention provide

a program including a computer readable program code for transmitting information in a communications network between a central unit on the one hand and a first and second decentralized unit on the other hand via a distribution point or for controlling a communications network, and to

a computer program product including a computer readable software code that when executed on a computing system performs a method for transmitting information in a communications network between a central unit on the one hand and a first and second decentralized unit on the other hand via a distribution point.

Exemplary embodiments of the present invention will be described with reference to certain drawings but the invention is not limited thereto but only by the claims. The drawings described are only schematic and are non-limiting. In the drawings, the size of some of the elements may be exaggerated and not drawn on scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described of illustrated herein.

The techniques described herein are subject to various implementations. For example, these techniques may be implemented in hardware (one or more devices), firmware (one or more devices), software (one or more modules), or combinations thereof. For a firmware or software, implementation can be through modules (for example, procedures, functions, or the like) that perform the functions described herein. The software codes may be stored in any suitable, processor/computer-readable data storage medium (a) or memory unit(s) and executed by one or more processors/computers. The data storage medium or the memory unit may be implemented within the processor/computer or external to the processor/computer, in which case it can be communicatively coupled to the processor/computer via conventional methods. Additionally, components of systems described herein may be rearranged and/or complimented by additional components in order to facilitate achieving the various aspects, goals, advantages, etc., described with regard thereto, and are not limited to the precise configurations set forth in a given figure, as will be appreciated by one skilled in the art.

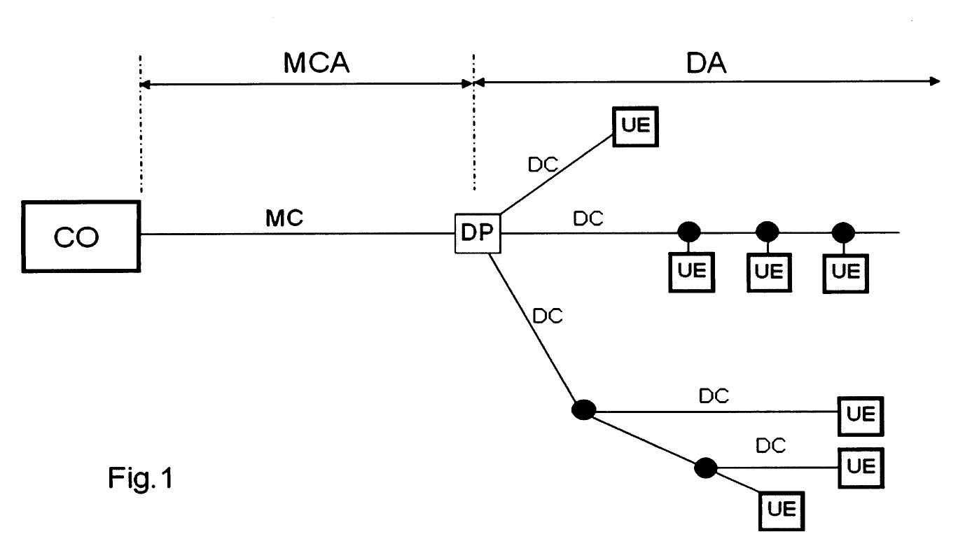

In FIG. 1, a part of a communications network 10 including a central unit (central office, CO) and a plurality of decentralized units (also called User Equipment (UE) or subscriber terminals) is schematically represented. The central unit CO (also called central office) is part of an analog or digital communications network 10 like the Public Switched Telephone Network (PSTN) or the Integrated Services Digital Network (ISDN). The subscribers or decentralized units UE are connected to the central unit CO by way of subscriber lines. Such subscriber lines have usually a length of up to about 8000 meters (resulting from the attenuation requirements for signal transmission in a narrow band frequency range of about 300 Hz to 3400 Hz (adapted to analog telephony services)). Usually, the subscriber lines for a plurality of subscribers or decentralized units UE are routed commonly from the central unit CO to a distribution point DP via a main cable MC. The main cable MC is usually used to route a plurality of dedicated subscriber lines over a distance of, e.g., a few kilometers, for example to a suburb or the like to the distribution point DP. From the distribution point DP the subscriber lines are routed by way of distribution cables DC to the individual decentralized units UE or subscriber terminals.

As far as broad band data transmission is concerned, the transmission capacity (or bandwidth) of the subscriber lines between the central unit CO and the decentralized units UE strongly depends, besides other parameters such as cross talk between different pairs of cables, primarily on the length of the cable. E.g., a cable length of 5 kilometers or more results in a data transmission capacity in the range of a few hundreds of kBaud, a cable length of 3 km results in at most 6 MBaud, and a cable length of at most a few hundreds of meters allow data transmission capacities of 16 MBaud.

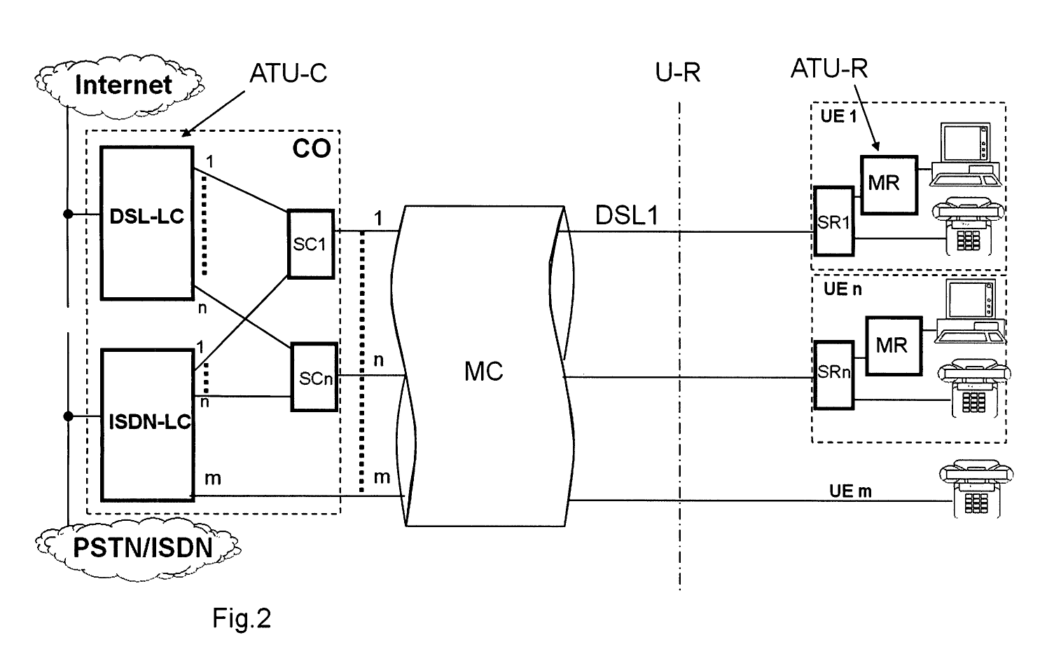

In FIG. 2, a more detailed representation of the connection between a central unit CO and a plurality of decentralized units UE according to a conventional system is schematically illustrated. The central unit CO usually includes a narrow band component (ISDN-LC, Integrated Services Digital Network Line Card) and a broad band component (DSL-LC, Digital Subscriber Line Line Card). The narrow band component (ISDN-LC, Integrated Services Digital Network Line Card) includes usually narrow band analog interfaces (a/b interface) and/or narrow band digital interfaces Uₖ₀ for the connection of the subscriber lines to the analog Public Switched Telephone Network (PSTN) or the digital Integrated Services Digital Network (ISDN). The broad band component (DSL-LC, Digital Subscriber Liner Line Card) is usually part of a Digital Subscriber Line Area Multiplexer (DSLAM) that provides towards the decentralized units a plurality of Digital Subscriber Line (DSL) lines. Usually, the decentralized units are connected to the subscriber lines by way of a modem device and/or by way of a router device. This is designated by reference sign MR.

Usually by way of a splitter device (SC1, SCn), both the narrow band signal and the broad band signal for a specific decentralized unit UE are brought together on the corresponding subscriber line that is routed to the subscriber terminal. At the subscriber terminal end of the subscriber line, the broad band signal and the narrow band signal are again separated by a splitter device. The designations ATU-C, ATU-R and U-R refer to the ITU-T (International Telecommunication Union Telecommunication Standardization Sector) reference points of such a Digital Subscriber Line connection.

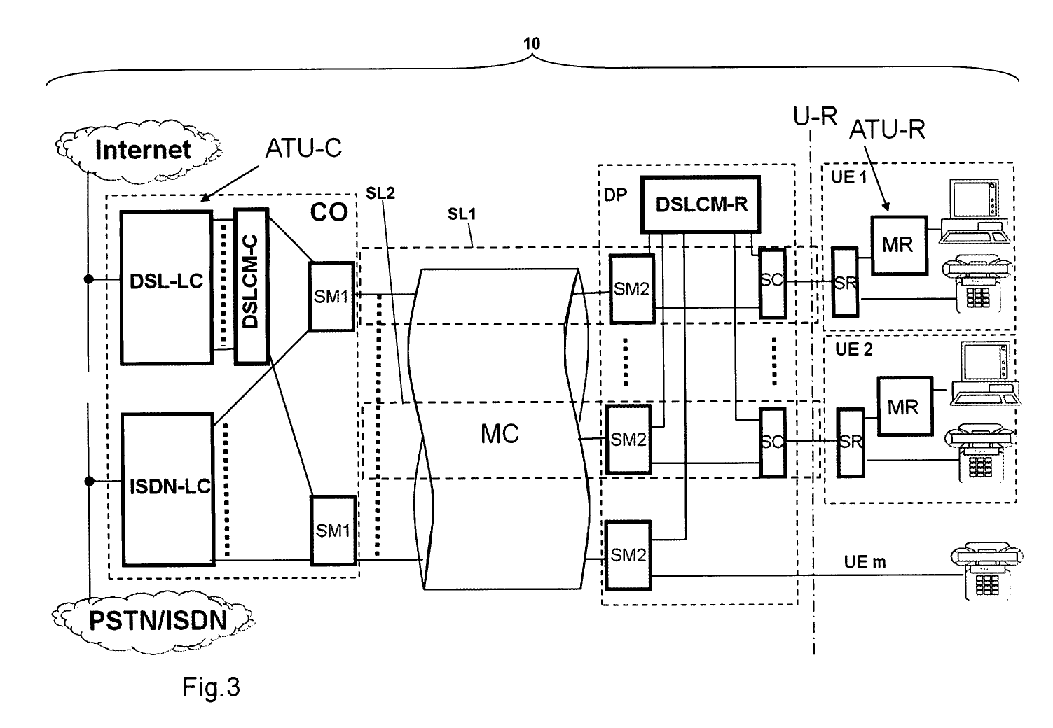

In FIG. 3, a more detailed representation of the connection between a central unit CO and a first decentralized unit UE1 and a second decentralized unit UE2 according to an exemplary embodiment of the present invention is schematically illustrated. Again, the central unit CO includes a narrow band component (ISDN-LC, Integrated Services Digital Network Line Card) and a broad band component (DSL-LC, Digital Subscriber Line Line Card). The narrow band component (ISDN-LC, Integrated Services Digital Network Line Card) includes usually narrow band analog interfaces (a/b interface) and/or narrow band digital interfaces Uₖ₀ for the connection of the subscriber lines to the analog Public Switched Telephone Network (PSTN) or the digital Integrated Services Digital Network (ISDN). The broad band component (DSL-LC, Digital Subscriber Liner Line Card) is part of a Digital Subscriber Line Area Multiplexer (DSLAM) that provides towards the decentralized units a plurality of Digital Subscriber Line (DSL) lines. Both components can also be realized on a universal line card.

Between the central unit CO and the distribution point DP, the narrow band signal and the broad band signal for a specific decentralized unit UE1, UE2 is not necessarily transmitted on the same subscriber line.

The broad band signal is transmitted using a plurality of subscriber lines between the central unit CO and the distribution point DP. Hereinafter, the term of first data is used for data intended to be transmitted to the first decentralized unit UE1 in the downlink direction. Hereinafter, the term of second data is used for data intended to be transmitted to the second decentralized unit UE2 in the downlink direction. Hereinafter, the term of third data is used for data intended to be transmitted from the first decentralized unit UE1 in the uplink direction. Hereinafter, the term of fourth data is used for data intended to be transmitted from the second decentralized unit UE2 in the uplink direction. The transmission of the first and second data can either be realized separately (according to a first exemplary embodiment) or commonly (according to a second exemplary embodiment).

In case of a separate transmission of the first and second data, e.g. the following options can be realized for the transmission of the first data:

using the first subscriber line and the second subscriber line, or

using the first subscriber line and an additional subscriber line, and, e.g., the following options can be realized for the transmission of the second data:

using the second subscriber line and a further additional subscriber line, or

using the first subscriber line and the second subscriber line.

In case of a common transmission of the first and second data, e.g. the following options can be realized for the transmission of the first and second data:

using the first and second subscriber line, or

using the first and second subscriber line and one additional subscriber line or more additional subscriber lines.

Such data transmission is possible without reducing the possible data transmission bandwidth because usually not all decentralized units require a high data transmission at the same time. The decentralized units UE1, UE2 are connected to the subscriber lines by way of a modem device and/or by way of a router device. This is designated by reference sign MR.

The central unit CO provides for a Digital Subscriber Line Cable Multiplexer (DSLCM-C) at the ATU-C reference point. Such a Digital Subscriber Line Cable Multiplexer (DSLCM-C) is able to split data intended for a transmission to the first decentralized unit UE1 via a first subscriber line SL1 and via a second subscriber line SL2. Such data are hereinafter also called first data. The Digital Subscriber Line Cable Multiplexer (DSLCM-C) is also able to split data intended for a transmission to the second decentralized unit UE2 via the first subscriber line SL1 and via the second subscriber line SL2. Such data are hereinafter also called second data. At the distribution point DP, a Digital Subscriber Line Cable Multiplexer (DSLCM-R) is used to merge the first data from the various subscriber lines SL1, SL2 to transmit the first data via a distribution cable DC to the first decentralized unit UE1. Furthermore, the Digital Subscriber Line Cable Multiplexer (DSLCM-R) at the distribution point DP merges the second data from the various subscriber lines SL1, SL2 to transmit the second data via a distribution cable DC to the second decentralized unit UE2. The first subscriber line SL1 and the second subscriber line SL2 are at least partly separated between the distribution point DP and the first/second decentralized unit UE1/UE2 (due to the fact that the first decentralized unit UE1 and the second decentralized unit UE2 are located at different locations). In most cases, the decentralized units UE1, UE2 will be connected by way of only a copper double wire, i.e. the first subscriber line SL1 and the second subscriber line SL2 correspond to a copper double wire, respectively.

Due to the fact that the residual distribution cable from the distribution point DP to the first and second decentralized unit UE1, UE2 is much shorter than the complete distance between the central unit CO and the first and second decentralized unit UE1, UE2, a much higher transmission rate (bandwidth) is possible to transmit on the residual subscriber line between the distribution point DP and the first/second decentralized unit UE1, UE2 without the need to install a Digital Subscriber Line Area Multiplexer (DSLAM) in every distribution point DP and the need to install an additional high bandwidth connection such as an optical fibre to such a Digital Subscriber Line Area Multiplexer (DSLAM) in every distribution point DP.

In order to further enhance the data transmission capacity of the connection between the central unit CO and the first and second decentralized unit UE1, UE2, a further embodiment utilizes additional subscriber lines that are present in the main cable between the central unit CO and the distribution point DP but that are not in use by a respective subscriber. Such an additional subscriber line is schematically shown in FIG. 3. Both the Digital Subscriber Line Cable Multiplexer (DSLCM-C) in the central unit CO and the Digital Subscriber Line Cable Multiplexer (DSLCM-R) in the distribution point DP should have access to as many subscriber lines between the central unit CO and the distribution point DP as possible.

The multiplexing and demultiplexing actions of the Digital Subscriber Line Cable Multiplexer (DSLCM-C) in the central unit CO and the Digital Subscriber Line Cable Multiplexer (DSLCM-R) in the distribution point DP are not only performed for the direction from the central unit CO to the decentralized unit UE1, UE2 but also in the opposing direction. This means that the Digital Subscriber Line Cable Multiplexer (DSLCM-R) in the distribution point DP is able to split data intended for a transmission from the first decentralized unit UE1 (to the central unit CO) via the first subscriber line SL1 and via a second subscriber line SL2 (and possibly via the additional subscriber line). Such data are hereinafter also called third data. The Digital Subscriber Line Cable Multiplexer (DSLCM-R) in the distribution point DP is also able to split data intended for a transmission from the second decentralized unit UE2 (to the central unit CO) via the first subscriber line SL1 and via the second subscriber line SL2 (and possibly via the additional subscriber line). Such data are hereinafter also called fourth data. At the central unit CO, the Digital Subscriber Line Cable Multiplexer (DSLCM-C) is used to merge the third data from the various subscriber lines SL1, SL2 and to merge the fourth data from the various subscriber lines SL1, SL2.

Different possibilities exist for the handling of the narrow band signal. For example, a conventional method can be used, i.e. each subscriber line SL1, SL2 transmits the corresponding narrow band signals (i.e. for the first decentralized unit UE1 on the first subscriber line SL1 and for the second decentralized unit UE2 on the second subscriber line SL2). It is also possible for a plurality of narrow band signals to be transmitted on other subscriber lines, e.g. in order to minimize cross-talk effects within the main cable. For separating the narrow band signal from the broad band signal, splitter devices SM1, SM2, SC are used. The designations ATU-C, ATU-R and U-R refer to the ITU-T (International Telecommunication Union Telecommunication Standardization Sector) reference points of such a Digital Subscriber Line connection.

1-15. (canceled)

16. A method for transmitting first data to a first decentralized unit in a communications network from a central unit via a distribution point and via a first subscriber line serving the first decentralized unit and at least one other subscriber line serving at least one other decentralized unit, the method comprising:
splitting the first data at the central unit;
transmitting the split first data from the central unit to the distribution point using the first subscriber line and the at least one other subscriber line; and
merging, at the distribution point, the split first data on the first subscriber, line for transmission of the first data to the first decentralized unit.

17. The method according to claim 16, wherein the at least one other subscriber line comprises a second subscriber line for transmission of second data from the central unit to a second decentralized unit, and where in the method further comprises:
splitting, at the distribution point, third data for transmission from the first decentralized unit to the central unit;
transmitting the split third data from the distribution point to the central unit using the first subscriber line and at least one of the at least one other subscriber line;
merging the split third data at the central unit.

18. The method according to claim 16, wherein for the transmission of the first data from the central unit to the distribution point, a maximum bandwidth is assigned to the first data corresponding to transmission capacity of the first subscriber line between the distribution point and the first decentralized unit.

19. The method according to claim 17, wherein for the transmission of the third data from the distribution point to the central unit, a maximum bandwidth is assigned to the third data corresponding to the transmission capacity of the first subscriber line between the first decentralized unit and the distribution point.

20. The method according to claim 16, wherein transmitting the split first data from the central unit to the distribution point uses at least two subscriber lines other than the first subscriber line.

21. The method according to claim 16, wherein the first data includes a narrow band portion.

22. The method according to claim 16, wherein the transmission of the first data is realized dependent on at least one of attenuation and cross talk properties of the first subscriber line and the at least one other subscriber line.

23. A method for transmitting first data to a first decentralized unit and second data to a second decentralized unit in a communications network from a central unit via a distribution point and via a first subscriber line serving the first decentralized unit and via a second subscriber line serving a second decentralized unit, the method comprising:
multiplexing the first and second data at the central unit;
transmitting the multiplexed first and second data from the central unit to the distribution point using the first and second subscriber lines; and
demultiplexing at the distribution point the first data for transmission to the first decentralized unit and the second data for transmission to the second decentralized unit.

24. The method according to claim 23, further comprising:
multiplexing third data for transmission from the first decentralized unit to the central unit and fourth data for transmission from the second decentralized unit to the central unit at the distribution point on the first and second subscriber lines;
transmitting the multiplexed third and fourth data from the distribution point to the central unit using the first and second subscriber lines; and
demultiplexing the third and fourth data at the central unit.

25. The method according to claim 23, wherein for the transmission of the multiplexed first and second data from the central unit to the distribution, point, a maximum bandwidth is assigned to the first data corresponding to transmission capacity of the first subscriber line between the distribution point and the first decentralized unit.

26. The method according to claim 24, wherein for the transmission of the multiplexed third and fourth data from the distribution point to the central unit, a maximum bandwidth is assigned to the third data corresponding to the transmission capacity of the first subscriber line between the first decentralized unit and the distribution point.

27. The method according to claim 23, wherein at least one additional subscriber line is used between the central unit and the distribution point for transmitting the multiplexed first and second data from the central unit to the distribution point.

28. The method according to claim 23, wherein the first and second data each comprise a narrow band portion.

29. The method according to claim 23, wherein the transmission of the multiplexed first and second data is realized dependent on at least one of attenuation and cross talk properties of the first and second subscriber lines.

30. A system for transmitting first data to a first decentralized unit in a communications network from a central unit via a distribution point and via a first subscriber line serving the first decentralized unit and at least one other subscriber line serving at least one other decentralized unit, the system comprising:
a first multiplex unit for splitting the first data at the central unit on the first subscriber line and the at least one other subscriber line, wherein the first data are transmitted from the central unit to the distribution point using the first subscriber line and the at least one other subscriber line;
a second multiplex unit for merging, at the distribution point (DP), the split first data on the first subscriber line for transmission to the first decentralized unit.

31. The system according to claim 30, wherein:
the second multiplex unit is further configured for splitting third data for transmission from the first decentralized unit to the central unit at the distribution point on the first subscriber line and the at least one other subscriber lines, wherein the third data is transmitted from the distribution point to the central unit using the first subscriber line and the at least one other subscriber line; and
the first multiplex unit is further configured for merging the split third data at the central unit.

32. A system for transmitting first data to a first decentralized unit and second data to a second decentralized unit in a communications network from a central unit via a distribution point and via a first subscriber line serving the first decentralized unit and via a second subscriber line serving a second decentralized unit, the method comprising:
a first multiplex unit for multiplexing the first and second data at the central unit on the first and second subscriber lines, wherein the first and second data are transmitted from the central unit to the distribution point using the first and second subscriber lines; and
a second multiplex unit for demultiplexing, at the distribution point, the first data on the first subscriber line for transmission to the first decentralized unit and the second data on the second subscriber line for transmission to the second decentralized unit.

33. The system according to claim 32, wherein:
the second multiplex unit is further configured for multiplexing third data for transmission from the first decentralized unit, to the central unit and fourth data for transmission from the second decentralized unit to the central unit at the distribution point on the first second subscriber lines, wherein the multiplexed third and fourth data is transmitted from the distribution point to the central unit using the first and second subscriber lines; and
the first multiplex unit is further configured for demultiplexing the third and fourth data at the central unit.

34. One or more non-transitory computer-readable media having processor-executable instructions for transmitting first data to a first decentralized unit in a communications network from a central unit via a distribution point and via a first subscriber line serving the first decentralized unit and at least one other subscriber line serving at least one other decentralized units stored thereon, the processor-executable instructions, when executed by one or more processors, causing the following steps to be performed:
splitting the first data at the central unit;
transmitting the split first data from the central unit to the distribution point using the first subscriber line and the at least one other subscriber line; and
merging, at the distribution point, the split first data on the first subscriber line for transmission of the first data to the first decentralized unit.

35. One or more non-transitory computer-readable media having processor-executable instructions for transmitting first data to a first decentralized unit and second data to a second decentralized unit in a communications network from a central unit via a distribution point and via a first subscriber line serving the first decentralized unit and via a second subscriber line serving a second decentralized unit stored thereon, the processor-executable instructions, when executed by one or more processors, causing the following steps to be performed:
multiplexing the first and second data at the central unit;
transmitting the multiplexed first and second data from the central unit to the distribution point using the first and second subscriber lines; and
demultiplexing at the distribution point the first data for transmission to the first decentralized unit and the second data for transmission to the second decentralized unit.
